(19) United States
(12) Patent Application Publication
(10) Pub. No.: US 2009/0293071 A1
(43) Pub. Date: Nov. 26, 2009

(54) Computer interface controller

(75) Inventor: Cheng-Hung Huang, Taipei County (TW)

Correspondence Address: BACON & THOMAS, PLLC, 625 SLATERS LANE, FOURTH FLOOR, ALEXANDRIA, VA, 22314-1176, US

(73) Assignee: Tenx Technology Inc., Taipei County (TW)

(21) Appl. No.: 12/153,469

(22) Filed: May 20, 2008

(51) Int. Cl. G06F 9/54

(52) U.S. Cl. 719/327

(57) ABSTRACT

The computer interface controller of this invention connects a peripheral device with a computer device through the computer communication interface provided in the computer device and comprises a central controller device, a computer interface controller device, a driver program memory, an audio output device, an audio input device, a virtual optical disc drive controller device and a driver program selection device. The optical disc drive controller device announces to the computer device that the computer interface controller is an optical disc drive and provides a driver program stored in the driver program memory to the computer device according to an operation system selected by the user, to enable the computer device to drive the peripheral device.

### FIELD OF THE INVENTION

The present invention relates to a computer interface controller, especially to a computer interface controller for the portable peripheral devices that supports the multimedia functions and operates under a plurality of operation systems.

### BACKGROUND OF THE INVENTION

In the current technology, all multimedia products need to be portable, since the user would carry the multimedia product with him/her all the times. The multimedia products are designed to be capable of being independently operated. When being on use, portable multimedia products have to be cooperated with a plurality of sensational stimulations, so that the interest of the users can by aroused by the visual and audio stimulations. The USB interface provides an interface connecting the multimedia products and the computer, whereby the computer may read and store data in the multimedia products. However, most products that use the USB interface operate in the passive mode.

Take the blood pressure meter as an example. The user of the blood pressure meter is required to record the readings of the meter daily. After having recorded the readings for a predetermined period of time such as one month, the blood pressure meter would generate a chart showing the variations of the readings. The user may use the chart to monitor his/her blood pressure. The chart may be provided to the family physicians for their reference.

Since most users of the portable products are not professionals in the computer science, they are not trained to edit the data obtained from the daily measurements or to use the recorded data to analyze and to make judgments. As a result, all the recorded data are merely data for these users. Some computer software would provide the functions of processing and analyzing these data. However, it is difficult for most untrained users to operate the peripheral devices in connect the computer and to download the recorded data. For such portable devices, such as the step counter, heartbeat counter, the pulse counter, the body fat tester, etc, it is thus necessary to provide a computer interface that makes the connection of the portable devices and the computer easy.

Take the digital photo display as another example. The digital photo display displays the image of the digital still photos and the digital motion pictures. It is also possible to add the sound effects to the displays. In addition, the digital photo display is portable. However, due to the relative small size of the display device of the digital photo display, it is desirable to connect the digital photo display with a personal computer for displaying the photos stored therein and for other operations. The conventional digital photo display does not support the more than one operation system. If the computer in connection with the digital photo display uses an operation system other than that of the digital photo display, the photos stored in the digital photo display may not be displayed at the displaying device of the computer. Even if the digital photo display supports a plurality of operation systems, the complicated installation operations would consume so much time that very few people could wait.

It is thus necessary to provide a computer interface controller for the peripheral devices whereby the peripheral devices may support a plurality of operation systems selectively.

It is also necessary to provide a computer interface controller for the portable peripheral devices to enable the peripheral devices to plug-and-play.

It is also necessary to provide a computer interface controller for the peripheral devices to support a plurality of data transmission interface specifications.

### OBJECTIVES OF THE INVENTION

The objective of this invention is to provide a novel computer interface controller for the peripheral devices.

Another objective of this invention is to provide a computer interface controller for portable peripheral devices to enable the peripheral devices to plug-and-play.

Another objective of this invention is to provide a computer interface controller for portable peripheral devices to support a plurality of data transmission interface specifications.

### SUMMARY OF THE INVENTION

In order to realize the above objectives, the computer interface controller of this invention comprises a central controller device, a computer interface controller device, a driver program memory, an audio output device, an audio input device, a virtual optical disc drive controller device, and a driver program selection device. The computer interface controller of this invention integrates into one semiconductor chip, has the functions of a multifunctional video and audio controller, a plurality of USB data transmission interface and a virtual optical disc drive, supports a plurality of computer operation systems, provides the driver programs for a plurality of peripheral devices, and realizes the plug-and-play functions of the peripheral device in connection with the invented computer interface controller.

The central controller device is used to control the interfacing application functions of the peripheral device in connection with the computer interface controller and to support the data and information transmissions between them. The computer interface controller device supports the communications and the input-output controls with a computer device through a computer communication interface. The driver program memory is in connection with the computer interface controller device, and is used to store the driver programs of the peripheral device in connection with the computer interface controller. The audio output device is in connection with the central controller device, and is used to control the outputs of the audio signals. The audio input device is in connection with the central controller device, and is used to convert the input audio signals into digital signals. An amplifier and an audio controller may be included in the audio input device to process the input voice or sound signals.

The virtual optical disc controller device is connected with the central controller device, and is used to announce to the computer device that the computer interface controller is an optical disc drive, to selectively actuate the driver programs that are stored in the virtual optical disc drive and that support the operation system selected by the user, and to provide the driver programs to the computer device, so that the peripheral device may be driven. In addition, the driver program selection device is in connection with the central controller device, and is used to selectively actuate the driver programs stored in the virtual optical disc drive.

The computer interface controller of the present invention may be used as the computer interface controller for the portable peripheral devices. The portable peripheral device may be a plug-and-play portable peripheral device or a portable peripheral device comprising an audio medium controller device and at least one computer operation system. The computer interface controller of this invention communicates with a computer device through a communication interface, which may be a wired interface or a wireless interface. If it is a wired interface, it may be the USB interface, the PCMCIA interface, the CardBus interface, the IEEE1394 interface, the PCI interface etc. If it is a wireless interface, it may be the infrared interface, the Bluetooth interface, the radio interface etc. The central controller device of the present invention is preferably a microcontroller or a microprocessor.

The computer interface controller may include other elements. For example, a bulk transfer node device allows the access of large quantity of data in the peripheral device. An upload node device announces to the computer device that the peripheral device is a standard peripheral, such as a standard keyboard or a standard mouse. An upload and download node device announces to the computer device that the peripheral device is a peripheral device with the bulk data read/write capability. A bidirectional data transmission interface device is embedded with a plurality of bidirectional data transmission interfaces to support the bidirectional data transmission peripheral devices. The embedded data transmission interface of the bidirectional data transmission interface device may be at least two selected from the followings: The SPI interface, the SmartCard reader interface, the UART interface and the GPIO interface.

The driver program memory is used to store the driver programs of the peripheral device. The driver program memory is preferably an external memory device, which may be a serial flash memory, a NOR flash memory, an NAND flash memory or a memory card.

The output equipment of the audio output device is preferably a device that outputs the audio signals through at least one D-type amplifier. The audio output device may be connected with an external speaker or other output equipments, to generate the music or voices. On the other hand, the audio input device converts the input audio signals into the digital signals and stores the digital signals in, for example, a peripheral memory access device.

The driver program selection device selectively actuates the driver programs stored in the virtual optical disc drive, preferably according to the operation system selected by the user or by the central controller device. In the latter case, the driver program selection device selects the operation system according to the determination of the central controller device and changes the driver program to be actuated automatically.

When the virtual optical disc drive controller device announces the computer interface controller to be an optical disc drive, the optical disc drive is preferably one announced in a virtual manner. In other words, the virtual optical disc controller device announces to the computer device that the computer interface controller is an optical disc drive in a virtual manner. The device used as the virtual optical disc drive in the communication between the virtual optical disc controller device and the computer device may be driver program memory. The driver program selection device of this invention is preferably a driver program memory controller.

### BRIEF DESCRIPTION OF THE DRAWINGS

FIG. 1 shows the block diagram of the computer interface controller of this invention.

FIG. 2 shows the flowchart of the protocol negotiation of the computer interface controller of this invention.

### DETAILED DESCRIPTION OF THE INVENTION

The embodiments of the computer interface controller will be described in the followings by referring to the drawings.

The present invention discloses a novel structure of the computer interface controller. In the present invention, a plurality of data transmission interfaces and a multimedia interface are integrated in a single computer interface controller. A virtual optical drive is used in the present invention to switch among the driver programs of the peripheral devices according to the selected operation system of the computer device. The computer interface controller of this invention realizes the plug-and-play functions of the peripheral devices.

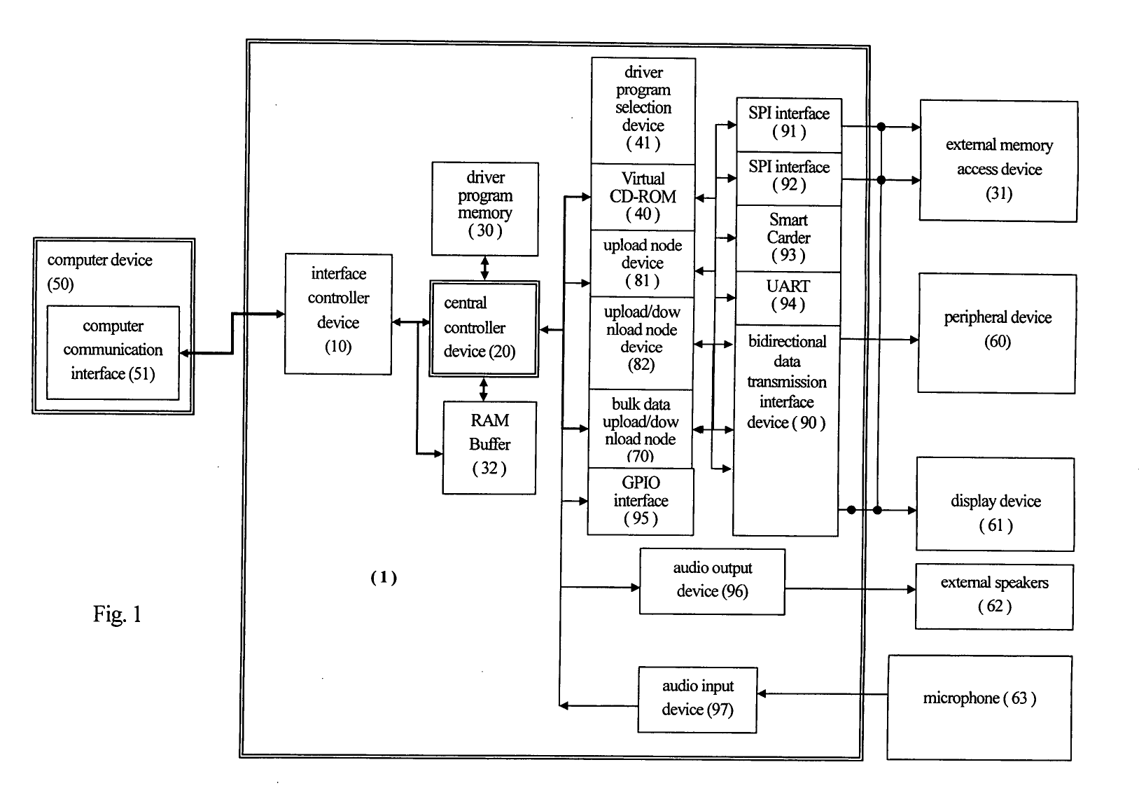

FIG. 1 shows the block diagram of the computer interface controller of this invention. As shown in this figure, the computer interface controller 1 of this invention connects a peripheral device 60 and a computer device 50, so as to enable the communications and the I/O controllers of the peripheral device 60 and the computer device 50. The computer interface controller 1 includes a central controller device 20, a computer interface controller device 10, a driver program memory 30, an audio output device 96, an audio input device 97, a virtual optical disc drive controller device 40, and a driver program selection device 41.

In the present invention, the central controller device 20 is used to control the interfacing application functions of the peripheral device 60, support the data and information transmissions between them. The computer interface controller 1 is connected to the central controller device 20. The computer interface controller device 10 supports the communications, and the input-output controls with the computer device 50 through a computer communication interface 51. The driver program memory 30 is in connection with the computer interface controller device 10, and is used to store the driver programs of the peripheral device 60 in connection with the computer interface controller 1. The audio output device 96 is in connection with the central controller device 20. The audio output device 96 is used to output the audio signals through, for example, a D-type amplifier. The audio output device 96 may be further connected to an external speakers 62, so as to generate the music or voices. The audio input device 97 is in connection with the central controller device 20. The audio input device 97 is used to convert the input audio signals into digital signals and to store the converted digital signals in the external memory access device 31. In other words, the audio input device 97 converts the input signals from the microphone 63 into the digital signals. The audio input device 97 may use an amplifier (not shown) to amplify the input audio signals of the microphone 63. Then, the audio input device 97 converts the amplified signals into the digital signals.

The virtual optical disc drive controller device 40 is connected with the central controller device 20. It announces to the computer device 50 that the computer interface controller 1 is an optical disc drive and communicates with the computer device 50, wherein the optical disc drive 40 uses the driver program memory 40 as the announced optical disc drive. The virtual optical disc drive controller device 40 provides the driver program to the computer device 50, so that the peripheral device 60 may be actuated.

The driver program selection device 41 is in connection with the central controller device 20, to selectively actuate the driver programs stored in the virtual optical disc drive 40.

In the structure of the computer interface controller as described above, the central controller device 20 may be any commercially available microcontroller or microprocessor. For those skilled in the art, it is possible to design the circuits of the central controller device or to obtain the license of the core program of a commercial microprocessor or microcontroller and include the circuits in the computer interface controller. The functions of the central controller device 20 are processing the data from the computer interface controller device 10, conducting necessary calculations, outputting data to the external interfaces. The related controls are known to those skilled in the art. Detailed descriptions thereof are thus omitted.

The computer communication interface 51 may be a USB interface, since the USB interface is the most popular interface in all kinds of peripheral devices. It however may be any wired interface or wireless interface. If it is a wired interface, it may be the PCMCIA interface, the CardBus interface, the IEEE1394 interface, the PCI interface etc. If it is a wireless interface, it may be the infrared interface, the Bluetooth interface, the radio interface etc. Since the controls and the circuitry of these interfaces are known to those skilled in the art, detailed descriptions thereof are omitted.

The major functions of the audio output device 96 are processing the audio data from the computer interface controller device 10, conducting necessary calculations, and outputting the audio data to the external speaker 62. A D-type amplifier may be used to amplify the audio signals. The related controls are also known to those skilled in the art. The detailed descriptions are thus omitted.

The audio input device 97 uses an amplifier (not shown) to amplify the inputs of the microphone 63, uses an analog-to-digital converter (not shown) to convert the input signals of the microphone 63 into digital signals, conducts necessary calculations, and then stores the processed signals in a memory (not shown). In another embodiment of this invention, the digitized audio data are stored in the external memory device 31. The related technology is known to those skilled in the art. Detailed descriptions thereof are omitted.

The virtual optical disc drive controller device 40 and the driver program selection device 41 are the major technical features of this invention. The virtual optical disc drive controller device 40 virtually announces an optical disc drive to the computer device 50, so to cause the computer device 50 to generate a negotiation interface for the virtual optical disc drive. The driver program selection device 41 determines the driver program memory to function as the virtual optical disc drive according to the operation system used in the computer device 50, and provides the driver program of the peripheral device 60 to the computer device 50. After the driver program is provided to the computer device 50, it may be installed in the computer device 50, or is simply accessible by the computer device 50.

In the embodiments of the present invention, the driver program memory 30 may be any memory device usable by a controller device. It may be a read only memory or a rewritable memory. In some other embodiments, the driver programs are stored in an external memory 31. In such a case, the virtual optical disc drive controller device 40 would use the external memory 31 as the driver program memory and as the virtual optical disc drive. The external memory 31 may be a serial flash memory, a NOR flash memory, an NAND flash memory, or a memory card.

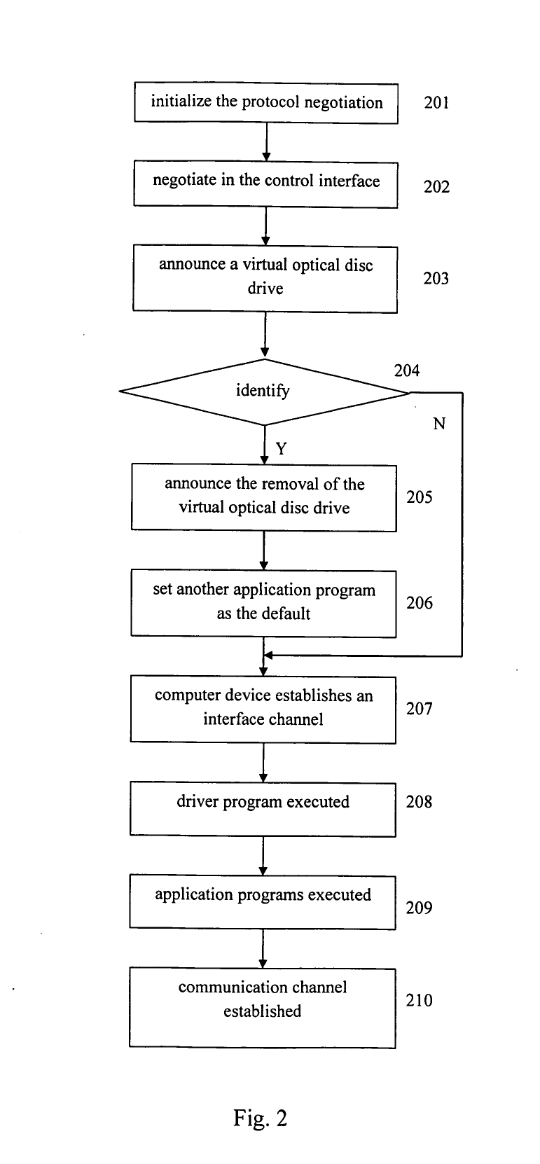

The virtual optical disc drive controller device 40 allows the peripheral devices, which don't support any of the standard communication interfaces, to communicate with the computer device 50 and to complete the protocol negotiations with the computer device 50, by selectively providing the driver programs stored in the driver program memory 30, which functions as the virtual optical disc drive, according to the selection of the driver program selection device 41. FIG. 2 is the flowchart of the protocol negotiations of the computer interface controller of the present invention. As shown in this figure, after the user connects the peripheral device 60 and the computer interface controller 1 with the communication interface 51 of the computer device 50 and the connection is detected by the computer device 50, the virtual optical drive controller device 40 initializes the protocol negotiation at 201. At 202 the computer device 50 starts to negotiate the control interface of the peripheral device 60. At 203 the virtual optical disc drive controller device announces a virtual optical disc drive to the computer device 50. At 204 the driver program selection device 41 automatically identifies the operation system used in the computer device 50. To identify the operation system, there are several possible methods. One method is to use an application program of the default operation system in the virtual optical disc drive controller device to negotiate with the computer device 50. If the no connections are established between the operation system of the computer device 50 and the application program, it is determined that the operation system and the application program are not compatible. Therefore, at 205 the computer interface controller 1 announces the removal of the virtual optical disc drive to the computer device 50. At 206 the driver program selection device 41 sets another application program as the default and the process goes back to step 201. Thereby, the protocol negotiations are initialized from the beginning.

In addition to the automatic identification approach as described above, it is also possible to allow the user to manually select through the driver program selection device 41 the application program that is compatible with the operation system of the computer device 50. A plurality of application programs that are compatible with the respective kinds of operation system may be stored in the external memory 31. As a result, after the user selects the application program, the computer device 50 would be able to execute the corresponding application program after a simple negotiation process.

Thereafter, at 207 the computer device establishes an interface channel for the virtual optical disc drive. At 208 the computer device executes the driver program stored in the driver program memory 30. At 209 the computer device 50 starts to execute the application programs of the peripheral device 60.

The application program may provide further data transmission interfaces, such as another USB data transmission interface. As a result, the user is allowed to upload and download data to and from the computer device 50 through the data transmission interface. At 210 the data access is operated through that newly established channel. On the other hand, if the computer does not execute other application programs, the user is still allowed to access the data stored in the memory 40, which is defined as the virtual optical disc drive, or in the driver program selection device 41, through the channel established for the virtual optical disc drive.

The computer interface controller of the present invention enables the connected peripheral device to operate in any computer device and in any operation system, without the need of the complicated parameter setting procedures. The protocol negotiations will be automatically conducted and completed. The “plug-and-play” functions of the peripheral device may thus be realized. For example, the users of the healthcare devices are mostly senior citizens, to whom the operations of the computer device are either too complicated or inconvenient. To download the data from the healthcare devices to the computer device and to edit the data are not possible. As a result, the data recorded in the healthcare devices are simply useless raw data. When the healthcare device is in connection with the computer interface controller of this invention, it is possible for the users to connect the peripheral device with a computer of any type and any operation system, such as the Windows® system of the Microsoft®, the Macintosh (computer or the Linux® system, to execute the application programs stored in the peripheral device, so to convert the data into valuable information of reference. The information so produced is easy to conceive and is informative. In addition, the dynamic graphic designs or motions and the audio contents provided by the peripheral device may be reproduced in the computer device connected.

Under the design of the present invention, the computer interface controller negotiates the communication protocol first through the communication interface of the computer, followed by announcing virtually an optical disc drive to the computer. After the applicable operation system is confirmed, the embedded virtual optical disc drive or the external memory functions as the virtual optical disc drive, whereby the driver program compatible with the operation system of the computer is selected to complete the setting up of the peripheral device. The program stored in the driver program memory 30 does not need to be installed or reside in the computer device. The user may execute the programs in the virtual optical disc drive directly. After the computer executes the application program in the virtual optical disc drive, the application program will execute the uploading and the downloading of data in a designated manner, without the need of going through the channel of the optical disc drive.

The present invention may be implemented in an integrated circuit, in the structure of an OTP/Flash/Mask IC. The peripheral manufacturer may determine the specifications of the IC according to the functional requirements, the specifications and the needs of the customers.

The present invention provides a computer interface controller for the portable, plug-and-play peripheral devices that may operate in any operation system. The computer interface controller may include other elements. For example, a bulk data upload/download node 70 may be used to establish a data transmission channel to transfer bulk data to the computer 50, whereby the user may use the computer to access the bulk data from the peripheral. For a consumer product that does not support the standard computer communication interface, the bulk data transfer node provides a data transmission speed higher than the ordinary data transmission node. When the peripheral device 60 is a memory or a peripheral device containing a data memory, the data transmission efficiency may be enhanced.

The present invention may further comprise an upload node device 81 and/or an upload/download node device 82, to announce to the computer device that the peripheral is a standard peripheral device such as a standard keyboard or a standard mouse. With this, the peripheral device may operate with the computer immediately after it is connected with the computer. When the peripheral device is a keyboard, a mouse or any device that uses the standard keyboard interface or the mouse interface, no installation process is required. Nevertheless, the present invention may further comprise a bidirectional data transmission interface device 90, in which a plurality of bidirectional data transmission interface is embedded to support the bidirectional data transmission peripherals. The embedded data transmission interface may be the SPI interface, the SmartCard reader interface, the UART interface or the GPIO interface. These interfaces and modules are known to those skilled in the art. Detailed descriptions thereof are thus omitted.

In a computer interface controller comprising all or parts of the above elements, a plurality of control interfaces for the corresponding peripheral devices has been integrated therein. Therefore, it may work with plenty of peripherals. The computer interface controller of this invention may function as the controller for a single peripheral device or a complex peripheral device. The user of the peripheral device does not need to install the peripheral device whenever the peripheral device is in connection with a new computer. The plug-and-play functions of the peripheral device are thus realized.

As the present invention has been shown and described with reference to preferred embodiments thereof, those skilled in the art will recognize that the above and other changes may be made therein without departing form the spirit and scope of the invention.

What is claimed is:

1. A computer interface controller to connect a peripheral device and a computer device comprising a computer communication interface, said computer interface controller comprising:
a central controller device used to control the interfacing application functions of the peripheral device, and to support the data and information transmissions between them;
a computer interface controller device used to support the communications and the input-output controls with the computer device through the computer communication interface;
a driver program memory connected with said central controller device to store driver programs for said peripheral device;
an audio output device in connection with said central controller device in its one end and to connect a speaker device in its other end;
an audio input device in connection with said central controller device in its one end, and used to connect a microphone in its other end;
a driver program selection device in connection with said central controller device, to select a driver program for said peripheral device from said driver programs in said driver program memory, wherein said selected driver program supports an operation system selected by a user; and
a virtual optical disc drive controller device in connection with said central controller device, to announce to said computer device that said computer interface controller is an optical disc drive, and to provide said driver program selected by said driver program selection device to said computer device, to enable said computer device to drive said peripheral device.

2. The computer interface controller according to claim 1, further comprising a bulk data upload/download node in connection with said central controller device and a bidirectional data transmission interface device.

3. The computer interface controller according to claim 1, further comprising an upload node device in connection with said central controller device and a bidirectional data transmission interface device.

4. The computer interface controller according to claim 1, further comprising an upload/download node device in connection with said central controller device and a bidirectional data transmission interface device in its other end.

5. The computer interface controller according to claim 3, wherein said bidirectional data transmission interface device comprises a plurality of bidirectional digital data transmission interfaces, and said bisectional data transmission interface device is in connection with an external memory device, said peripheral and a display device.

6. The computer interface controller according to claim 5, wherein said bidirectional data transmission interface is embedded with a plurality of digital data transmission interfaces, comprising at least two selected from the group consisted of the SPI interface, the SmartCard reader interface, the UART interface and the GPIO interface.

7. The computer interface controller according to claim 5, wherein said external memory device comprises at least one selected from the group consisted of the serial flash memory, the NOR type flash memory and the memory card.

8. The computer interface controller according to claim 1, wherein said audio output device is in connection with at least one D-type amplifier.

9. The computer interface controller according to claim 1, further comprising a GPIO interface in connection with said central controller device.

10. The computer interface controller according to claim 1, wherein said virtual optical disc drive controller defines said driver program memory as a virtual optical disc drive to communicate with the computer, whereby the driver programs in said driver program memory are provided to said computer device to drive said peripheral.

11. The computer interface controller according to claim 1, wherein said central controller device is a microcontroller or a microprocessor.

12. The computer interface controller according to claim 1, further comprising an analog-to-digital converter device, used to convert the input signals into digital signals, in connection with said central controller device and said audio input device.
